(19) United States
(12) Patent Application Publication
(10) Pub. No.: US 2026/0254660 A1
(43) Pub. Date: Aug. 27, 2026

(54) SYSTEMS AND METHODS FOR AUTOMATICALLY SCANNING SECURE SOCKETS LAYER CERTIFICATES IN A DISTRIBUTED NETWORK

(71) Applicant: BANK OF AMERICA CORPORATION, Charlotte, NC (US)

(72) Inventors: Madhu Bharathula, Morganville, NJ (US); Christopher Carver, Longwood, FL (US); Jeet Prabhakar Sankhe, Thane (IN); Khan Mohammed Mubashir Zafar Ahmed, Mumbai (IN); Dinesh Kumar P, Chennai (IN); Sudipto Chattopadhayay, St. Augustine, FL (US); Kyriacos Iacovou, Flushing, NY (US)

(73) Assignee: BANK OF AMERICA CORPORATION, Charlotte, NC (US)

(21) Appl. No.: 19/064,092

(22) Filed: Feb. 26, 2025

(51) Int. Cl. H04L 9/32

(52) U.S. Cl. CPC H04L 9/3263

(57) ABSTRACT

Systems, computer program products, and methods are described herein for automatically scanning secure sockets layer (SSL) certificates in a distributed network. The present disclosure is configured to identify a SSL certificate from at least one server; extract SSL certificate data from the SSL certificate; generate a current checksum for the SSL certificate based on the SSL certificate data; access a primary checksum associated with the SSL certificate, wherein the primary checksum is based on a historical SSL certificate from the at least one server or a related server; compare the current checksum to the primary checksum; and determine, based on the comparison of the current checksum to the primary checksum, the SSL certificate matches or does not match the historical SSL certificate for the at least one server.

### TECHNOLOGICAL FIELD

Example embodiments of the present disclosure relate to automatically scanning Secure Sockets Layer (SSL) certificates in a distributed network.

### BACKGROUND

In today's electronic environment, scanning secure sockets layer (SSL) certificates across different servers and without installing any clients or agents on these individual servers is needed to conduct more robust and computer power friendly. For instance, current systems that scan these SSL certificates cannot scan particular services or servers that are linked to messaging products without incurring undue delay and downtime, and these current systems are unable to scan these SSL certificates and report without undue delay or downloading of SSL certificate data every time, which in and of itself may incur unnecessary computing power in both storing each SSL certificate scanned and by uploading agents or clients at the servers. Thus, a system, computer program product, and/or computer implemented method that can automatically, efficiently, and securely scan SSL certificates in a distributed network is needed.

Applicant has identified a number of deficiencies and problems associated with scanning SSL certificates in a distributed network and determining when SSL certificates have been updated and/or need updating. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for automatically scanning Secure Sockets Layer (SSL) certificates in a distributed network.

In one aspect, a system for automatically scanning secure sockets layer certificates in a distributed network is provided. In some embodiments, the system may comprise: a memory device with computer-readable program code stored thereon; at least one processing device operatively coupled to the memory device and at least one communication device, wherein executing the computer-readable code is configured to cause the at least one processing device to: identify a secure sockets layer (SSL) certificate from at least one server; extract SSL certificate data from the SSL certificate; generate a current checksum for the SSL certificate based on the SSL certificate data; access a primary checksum associated with the SSL certificate, wherein the primary checksum is based on a historical SSL certificate from the at least one server or a related server; compare the current checksum to the primary checksum; and determine, based on the comparison of the current checksum to the primary checksum, the SSL certificate matches or does not match the historical SSL certificate for the at least one server.

In some embodiments, the historical SSL certificate and the primary checksum are accessed via an SSL tracking component stored remote from the at least one server or the related server (e.g., another server associated with the same entity, website, and/or the like that should also store the current or historical SSL certificate), and wherein executing the computer-readable code is further configured to cause the at least one processing device to: update, in an instance where the current checksum and the primary checksum do not match, the primary checksum and the historical SSL certificate in the SSL tracking component with the current checksum and the SSL certificate data. In some embodiments, executing the computer-readable code is further configured to cause the at least one processing device to: generate, based on updating the primary checksum and the historical SSL certificate in the SSL tracking component, an SSL tracking report comprising each of the historical SSL certificates that have been updated within a pre-determined period; generate an SSL tracking interface component comprising the SSL tracking report; and configure a graphical user interface of a user device associated with the SSL certificate with the SSL tracking interface component. In some embodiments, wherein a batch of SSL certificates is identified from a plurality of servers over the pre-determined period, and wherein the pre-determined period comprises at least one of twenty-four hours, seven days, or a month.

In some embodiments, executing the computer-readable code is further configured to cause the at least one processing device to: receive, by an SSL tracking component, a user-selected SSL identifier; access, by the SSL tracking component, the SSL certificate in real time based on the user-selected SSL identifier; generate, in an instance where the current checksum and the SSL certificate do not match, an SSL tracking report comprising the SSL certificate associated with the user-selected SSL identifier and associated SSL certificate data; and configure a graphical user interface of a user device associated with the user-selected SSL identifier with the SSL tracking report in real time or near real time to receiving the user-selected SSL identifier.

In some embodiments, the historical SSL certificate and the primary checksum are accessed via an SSL tracking component stored remote from the at least one server or the related server, and wherein, in an instance where the current checksum and the primary checksum match, the primary checksum in the SSL tracking component remains unchanged. In some embodiments, the SSL tracking component stores a timestamp of the current checksum with the primary checksum and the historical SSL certificate.

In some embodiments, executing the computer-readable code is further configured to cause the at least one processing device to: extract the SSL certificate data from the SSL certificate, wherein the SSL certificate data comprises at least one of application certificate data, intermediary certificate data, root certificate data, or trust data; and generate, using the SSL certificate data, the current checksum.

In some embodiments, executing the computer-readable code is further configured to cause the at least one processing device to: identify instance data associated with the SSL certificate, wherein the instance data comprises a plurality of ports comprising the SSL certificate at a plurality of servers; determine, based on the instance data, a prioritization list of the plurality of ports, wherein the prioritization is based on historical access to the plurality of ports; attempt a connection with each port on the prioritization list until a port is accessible; and extract the SSL certificate from the first port that is accessible. In some embodiments, executing the computer-readable code is further configured to cause the at least one processing device to: collect, in an instance where the plurality of ports in the prioritization list are inaccessible, each exception for each port that is inaccessible; analyze each exception and associated exception data; generate an SSL exception report interface component comprising the exception data for each exception; and configure a graphical user interface of a user device with the SSL exception report interface component.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for automatically scanning Secure Sockets Layer (SSL) certificates in a distributed network, in accordance with an embodiment of the disclosure;

FIG. 2 illustrates a process flow for automatically scanning Secure Sockets Layer (SSL) certificates in a distributed network, in accordance with an embodiment of the disclosure;

FIG. 3 illustrates a process flow for updating the primary checksum and the historical SSL certificate in a SSL tracking component, in accordance with an embodiment of the disclosure;

FIG. 4 illustrates a process flow for generating an SSL tracking report and configuring a graphical user interface to render the SSL tracking report on a user device, in accordance with an embodiment of the disclosure;

FIG. 5 illustrates a process flow for generating the current checksum for an SSL certificate, in accordance with an embodiment of the disclosure; and

FIG. 6 illustrates a process flow for identifying and extracting SSL certificates and associated SSL certificate data, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, devices, servers, ports, processing components, and the like, and/or the ability and opportunity to access and use the same. Some example implementations herein contemplate property held by a user, including property that is stored and/or maintained by a third-party entity.

In today's electronic environment, scanning secure sockets layer (SSL) certificates across different servers and without installing any clients or agents on these individual servers is needed to conduct more robust and computer power friendly. For instance, current systems that scan these SSL certificates cannot scan particular services or servers that are linked to messaging products without incurring undue delay and downtime, and these current systems are unable to scan these SSL certificates and report without undue delay or downloading of SSL certificate data every time, which in and of itself may incur unnecessary computing power in both storing each SSL certificate scanned and by uploading agents or clients at the servers. Thus, a system, computer program product, and/or computer implemented method that can automatically, efficiently, and securely scan SSL certificates in a distributed network is needed.

Accordingly, the present disclosure provides for the identification of a secure sockets layer (SSL) certificate from at least one server; the extraction of SSL certificate data from the SSL certificate; the generation of a current checksum for the SSL certificate based on the SSL certificate data; the accessing of a primary checksum associated with the SSL certificate, wherein the primary checksum is based on a historical SSL certificate from the at least one server or a related server; the comparison of the current checksum to the primary checksum; and the determination, based on the comparison of the current checksum to the primary checksum, of the SSL certificate matches or does not match the historical SSL certificate for the at least one server.

In other words, the disclosure provides a system, computer program product and computer implemented method for scanning SSL certificates by generating a current checksum value for each SSL certificate retrieved each distributed network component (e.g., server). The system may use a checksum generator based on all the certificate information extracted (e.g., CN, issued date, expiration date, trust score, and/or the like), and then the generated checksum for the current SSL certificate may be compared against the last checksum generated for the SSL certificate (which may be stored within the system and/or stored at a storage component connected to the system). Upon comparing the generated checksum to the last checksum, the system may determine if the SSL certificate has been updated and, in an instance where the SSL certificate has been updated (and the checksums don't match), then the system may store the generated checksum and SSL certificate details in the same storage component as the other checksums for the server. Otherwise, and in an instance where the checksums do match, then the system may indicate nothing has been updated and may delete the generated checksum and continue using the last checksum. Additionally, and in some embodiments, the system may comprise a user interface configured to indicate each of these SSL certificates, their information, and their checksums, to show a report of all the validated SSL certificates and any SSL certificates that need addressing.

What is more, the present disclosure provides a technical solution to a technical problem. As described herein, the technical problem includes scanning SSL certificates in a distributed network and determining when SSL certificates have been updated and/or need updating. The technical solution presented herein allows for the automatic scanning of SSL certificates in a distributed network in an efficient, secure, and automatic manner. In particular, the disclosure provided herein is an improvement over existing solutions to the scanning of SSL certificates, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

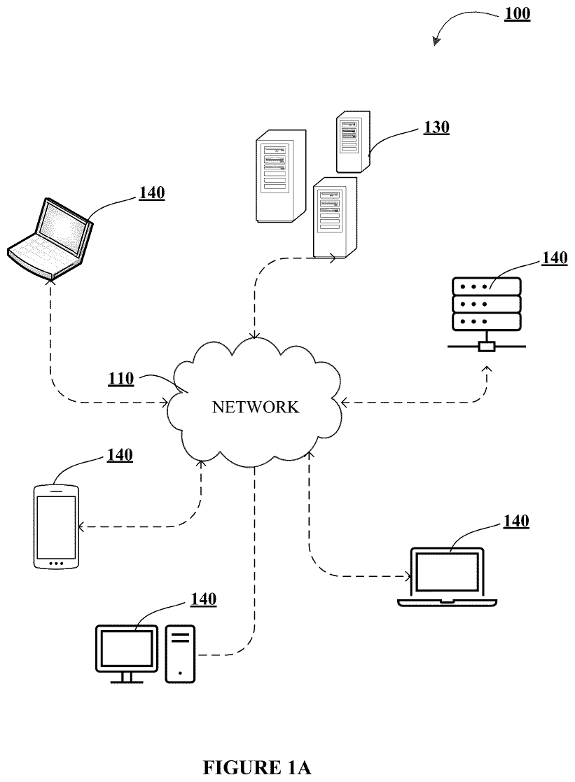

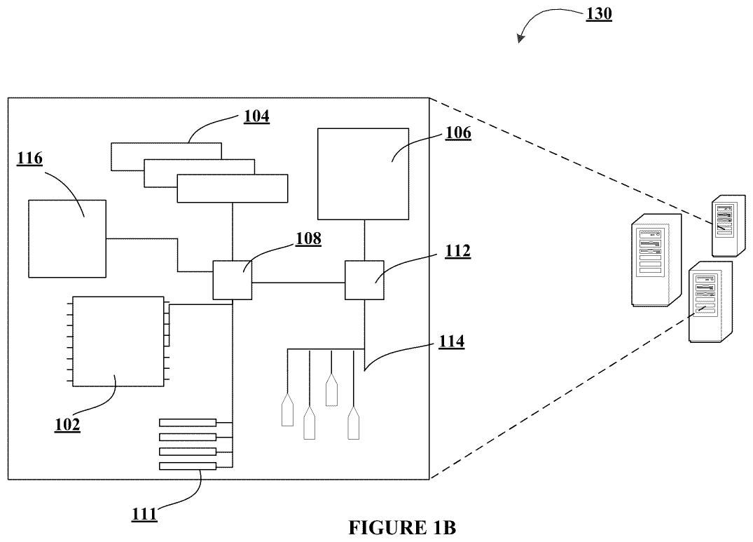

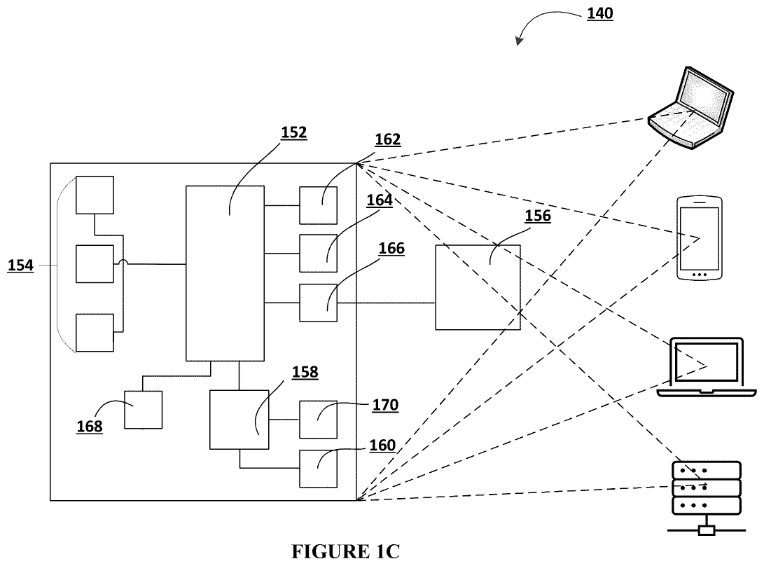

FIGS. 1A-1C illustrate technical components of an exemplary distributed computing environment for automatically scanning Secure Sockets Layer (SSL) certificates in a distributed network 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

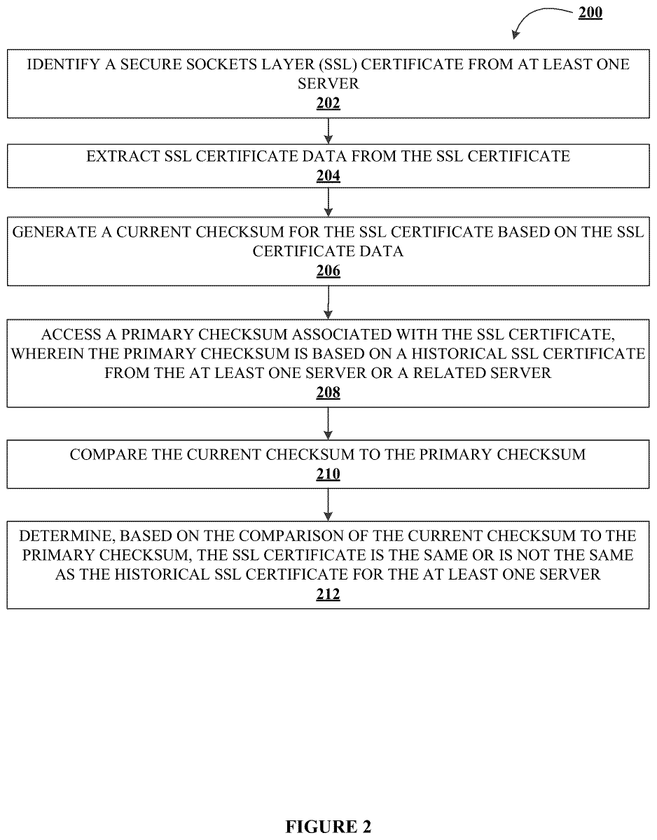

FIG. 2 illustrates a process flow 200 for automatically scanning Secure Sockets Layer (SSL) certificates in a distributed network, in accordance with an embodiment of the disclosure. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process 200.

As shown in block 202, the process flow 200 may include the step of identifying a secure sockets layer (SSL) certificate from at least one server. As used herein, the “SSL certificate” refers to a digital file that verifies a website's identity when a client (e.g., client server or client user device) are attempt access to and communication with the website. Thus, and as used herein, the SSL certificate may be stored on a host server, which may comprise one or more ports for connection with a client device/server. In some embodiments, the SSL certificate may be identified by a user submitting a user-selected identifier of an SSL certificate and/or a specific server or website identifier (e.g., a hypertext transfer protocol, or HTTP address) that needs to be analyzed. In some embodiments, the SSL certificate, server, and/or website may be identified based on the system keeping track of the current known SSL certificate and its expiration. Thus, and in some such embodiments, the SSL certificate that will be analyzed using the processes described herein may be identified for processing before (e.g., 6 hours, 12 hours, 24 hours, and/or the like) and/or immediately before (e.g., 1 hour, 30 minutes, and/or the like) an expected expiration of the current known SSL certificate. In some embodiments, the SSL certificate may be identified based on a batch process that regularly and at pre-defined intervals identifies and access particular SSL certificates to run the processes described herein (e.g., every 12 hours, every 24 hours, every week, and/or the like).

As shown in block 204, the process flow 200 may include the step of extracting SSL certificate data from the SSL certificate. For instance, the system may extract the SSL certificate data based on identifying and extracting the SSL certificate from its associated server, or the server that stores the SSL certificate that was identified in block 202. In some embodiments, the SSL certificate and its SSL certificate data may be extracted all at once from its server, and based on this extraction, the SSL certificate data may be parsed for further analysis and generation of a current checksum. Such an embodiment is described in further detail below.

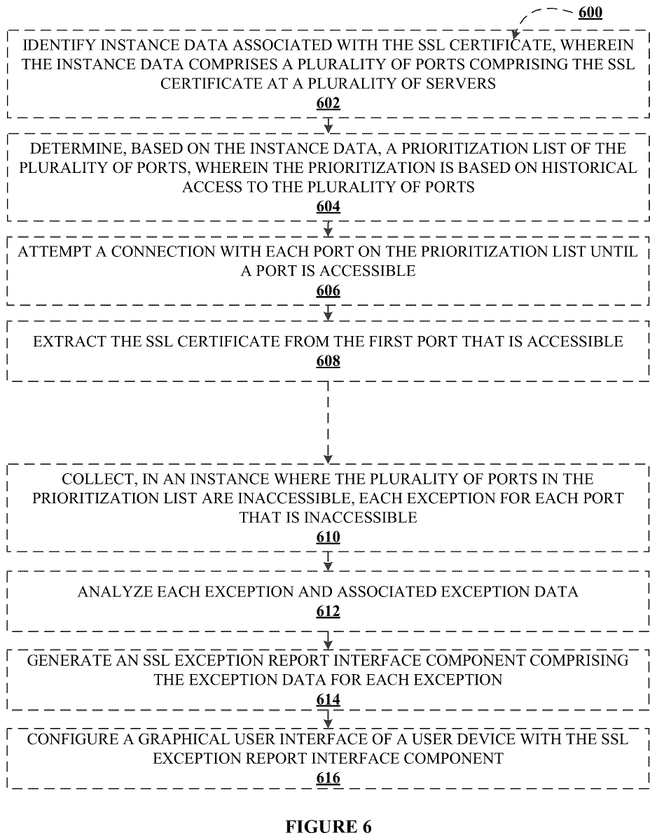

Additionally, and in some embodiments, the extraction of the SSL certificate and its SSL certificate data may occur based on identifying previous servers that hosted a historical SSL certificate for the same website or entity. Thus, and in some such embodiments, the system may automatically and efficiently determine which server to extract a current SSL certificate and its SSL certificate data from, based on previous extractions of historical SSL certificates associated with the same website that is associated with the current SSL certificate identified in block 202. Such an embodiment is described in further detail below with respect to FIG. 6.

In some embodiments, the extraction of the SSL certificate data may comprise extracting SSL certificate details provided by the host server, which may comprise the certificate itself, the application certificate (e.g., the common name (CN) data which identifies the specific domain name or entity the certificate is issued to, issued date of the certificate validating the application or website, expiration date of the certificate), the intermediary certificate (e.g., CN data which may be the value in the certificate's domain name (DN), issued date for the intermediate certificate, expiry date for the intermediate certificate), root certificate (CN of the server that the certificate protects, issued date for the root certificate, expiration date for the root certificate), and/or certificate authority (CA) client aliases (e.g., trust store, or repository/database where a client application may store trusted certificates from a certificate authority which comprise unique aliases for identification of trusted servers for SSL handshakes).

Importantly, and in a preferred embodiment of the disclosure provided herein, no clients, agents, or bots may need to be uploaded on or to the host server to access, scan, and/or extract the SSL certificates. Thus, and as used herein, the system described herein may be agent-less. In some embodiments, the system may identify an SSL certificate based on receiving an instance from a user device, whereby such an instance may comprise a message transmitted from the user/client device to a server to access a website, and based on instance data collected, the system may identify the associated SSL certificate, intended server, website, and/or the like, and from this identification, the system may extract the SSL certificate and its SSL certificate data from either any received instance data received back from the server, and/or extract the SSL certificate and its data directly from the server itself.

As shown in block 206, the process flow 200 may include the step of generating a current checksum for the SSL certificate based on the SSL certificate data. For instance, the system may generate a current checksum using the data from the SSL certificate. In some embodiments, the checksum may be generated using cryptographic techniques, such as via a hashing algorithm, which may generate a unique fixed string based on the input data (e.g., the SSL certificate data). Thus, and where the SSL certificate data comprises information that even slightly changes the next day when this process is run, the entire current checksum for the same SSL certificate/server may likewise completely change. In some embodiments, the system may use a CRC32 checksum algorithm to generate the current checksum and any other such checksums described herein (e.g., the primary checksum for historical SSL certificates, and/or the like). Thus, and in some preferred embodiments, the same checksum algorithm may be used to generate the current checksum as the checksum algorithm that was used to generate the primary checksum. In this manner, and in an instance where the current checksum and the primary checksum are being compared, the comparison may be a one-to-one comparison, and only those current checksums that were generated from a different SSL certificate from the historical SSL certificate will be flagged.

As shown in block 208, the process flow 200 may include the step of accessing a primary checksum associated with the SSL certificate, wherein the primary checksum is based on a historical SSL certificate from the at least one server or a related server. For example, the system may access a primary checksum from a database, repository, and/or the like associated with the system (e.g., stored within the system or stored within a component operatively coupled to the system). In some embodiments, such a primary checksum may be stored with an associated server identifier, port identifier for a server, website or entity identifier, and/or the like. In this manner, the system may efficiently access the primary checksum that is associated with the same server, website, entity, port, and/or the like, as the current SSL certificate that was identified in block 202.

Additionally, and as used herein, the primary checksum refers to a current known and stored checksum that was generated from the most-recently extracted SSL certificate from the same server, same port, same website, same instance, and/or the like. In this manner, the primary checksum is associated with the immediate-previous historical SSL certificate that had been extracted from a host server associated with an entity or website and that hasn't undergone a change or update. Thus, and in an instance where the primary checksum is different from the current checksum, the system may determine the historical SSL certificate has been updated at the server with a new or current SSL certificate (i.e., the SSL certificate the current checksum is based on).

In some embodiments, the historical SSL certificate and the primary checksum are accessed via an SSL tracking component stored remote from the at least one server or the related server. For instance, and as described briefly above, the system described herein may be preferred to be agent-less with respect to the host server(s), and thus an SSL tracking component remote from the host server(s) may be used to access and extract the SSL certificate(s) and their SSL certificate data. In some such embodiments, the SSL tracking component may be stored and operated within the system described herein, and may access the SSL certificate and its SSL certificate data without installing an agent, bot, and/or the like at the host server where the SSL certificate is stored. Further, and in some such embodiments, the system may access the SSL certificate and its SSL certificate data vie a port or socket which connects to an instance and collects the instance data during a communication between the client and the server. Thus, and in some such embodiments, the system may remain stateless, so there may be no caching, databases, and/or the like for the certificate extraction at the server, thus, and in an instance where the system may receive the same instance data the next day, the system may be unable to determine that the system had previously scanned that instance previously.

As shown in block 210, the process flow 200 may include the step of comparing the current checksum to the primary checksum. For example, such a comparison may comprise a one-to-one comparison of each of the characters within the checksums, and in an instance where at least one of the characters are different, then the system may determine the SSL certificate that generated the current checksum is different from the historical SSL certificate. In some embodiments, the system may streamline this comparison and only look at the number of characters in the checksum strings, and in an instance where the current checksum comprises a different number of characters (less than or more than the primary checksum's number of characters in the unique string), then the system may determine the SSL certificate that generated the current checksum is different from the historical SSL certificate. Thus, and as used herein, the term “comparison” refers to an analysis and determination of the similarities and differences between two or more objects (e.g., here, two checksums).

As shown in block 210, the process flow 200 may include the step of determining, based on the comparison of the current checksum to the primary checksum, the SSL certificate matches or does not match the historical SSL certificate for the at least one server. For example, the system may determine the SSL certificate matches the historical SSL certificate (and thus, no update to the SSL certificates for a website, entity, and/or the like has occurred), when the current checksum and the primary checksum match. In contrast, and where the current checksum and primary checksum do not match (e.g., based on the number of characters, the comparison of each character and their placement in the strings of checksums, and/or the like), then the system may determine the historical SSL certificate was updated at the host server with the current SSL certificate that was used to generate the current checksum.

Thus, and in an instance where the current SSL certificate was used to update the historical SSL certificate, the system may store the current SSL certificate, its SSL certificate data, and the current checksum as the new historical SSL certificate and the primary checksum. In this manner, and in some preferred embodiments, the system may conserve computing resources and storage resources by only saving the SSL certificate and its SSL certificate data once the SSL certificate updated a historical SSL certificate at a host server. Thus, and in contrast, the system may ignore the current SSL certificate and its SSL certificate data SSL certificate data. In other words, and in the instance where the current checksum and the primary checksum match, the primary checksum and the historical SSL certificate in the SSL tracking component remain unchanged.

In some embodiments, the SSL tracking component stores a timestamp of the current checksum with the primary checksum and the historical SSL certificate. Thus, and in some such embodiments whether the historical SSL certificate and the primary checksum remain unchanged, the system may still update the SSL tracking component to indicate when the latest process described herein was run and the historical SSL certificate was re-determined as current at the host server. Additionally, and in some embodiments, the system may likewise store a timestamp when the current checksum and current SSL certificate are updated in the SSL tracking component as the primary checksum and the historical SSL certificate.

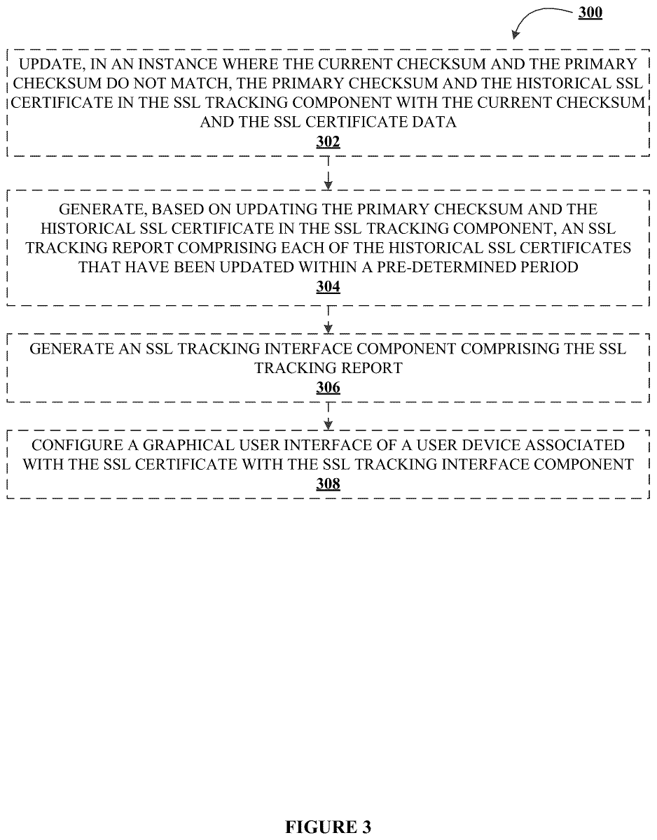

FIG. 3 illustrates a process flow 300 for updating the primary checksum and the historical SSL certificate in a SSL tracking component, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300.

In some embodiments, and as shown in block 302, the process flow 300 may include the step of updating, in an instance where the current checksum and the primary checksum do not match, the primary checksum and the historical SSL certificate in the SSL tracking component with the current checksum and the SSL certificate data. For instance, and in some such embodiments, the system may update the primary checksum and the historical SSL certificate in the SSL tracking component (e.g., in a database or repository associated with the SSL tracking component) with the current checksum and SSL certificate data. In this manner, and at future instances, the system may use the newly updated primary checksum to determine if the SSL certificate has been updated at a later time as compared to the newly updated historical SSL certificate. Thus, and in some embodiments and each time the SSL certificate is determined to have been updated, the system may overwrite the primary checksum and the historical SSL certificate with the newly updated current checksum and SSL certificate. Such an overwrite may conserve computing resources and storage resources by allowing for limited data to query when searching for the primary checksum and historical SSL certificate and by limiting the storage needed for each SSL certificate associated with each website or entity.

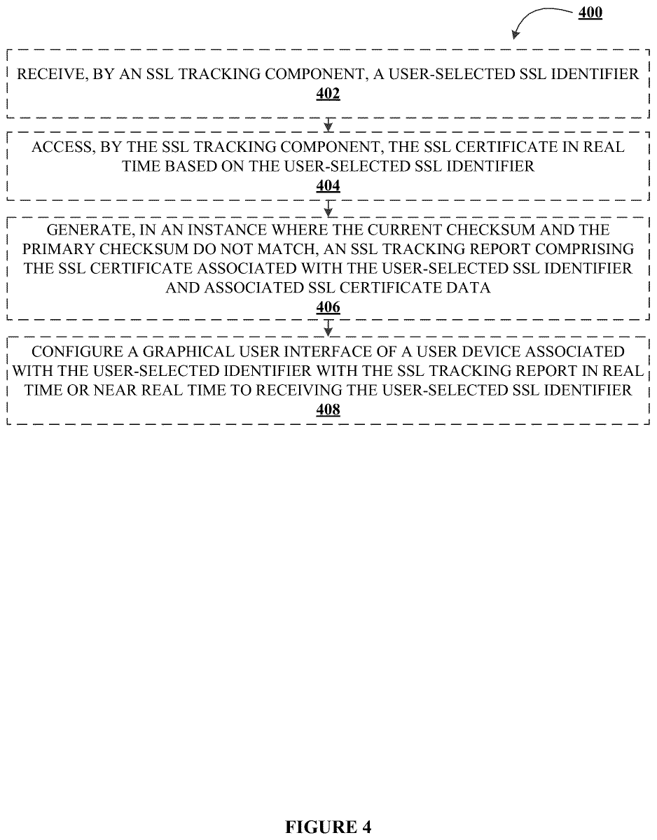

In some embodiments, and as shown in block 304, the process flow 300 may include the step of generating, based on updating the primary checksum and the historical SSL certificate in the SSL tracking component, an SSL tracking report comprising each of the historical SSL certificates that have been updated within a pre-determined period. Thus, and in some such embodiments, the SSL tracking report may comprise each of the historical SSL certificates that have been updated within a pre-determined period (e.g., as a batch process, may show all the SSL certificates that have been updated within the pre-determined period, such as within the last 24 hours, 12 hours, week, and/or the like, since the last batch was processed by the system). In some such embodiments, a batch of SSL certificates is identified from a plurality of servers over the pre-determined period, and wherein the pre-determined period comprises at least one of twenty-four hours, seven days, or a month. In contrast, and in some embodiments, the system may run the processes described herein in real-time upon receiving a user-selected SSL identifier is received, and the processes described herein are run only on the SSL certificate extracted from a server associated with the user-selected SSL identifier. Such an embodiment is described in greater detail below with respect to FIG. 4.

In some embodiments, the SSL tracking report may be generated using computer-readable program code that is configured to show the data associated with all the SSL certificates that have been identified as having been updated within the pre-determined period and/or the SSL certificates that were updated and identified with a user-selected SSL identifier. In some embodiments, SSL tracking report may comprise the SSL certificate data extracted and used to generate the checksum, the issue date for the root, intermediary, and application certificates; the expiration date for the current SSL certificate for the root, intermediary, and application certificates, common name data of the root, intermediary, and application certificates; certificate authority data; and/or the like. Further, and in some embodiments, the SSL tracking report may comprise only a snapshot of the SSL certificate, such as but not limited the overall expiration date, issue date, common name of the application/website, server identifier/port identifier, and/or the like. Thus, and in some such embodiments, the SSL tracking report may comprise data needed by users accessing these servers and/or these entity websites.

In some embodiments, and as shown in block 306, the process flow 300 may include the step of generating an SSL tracking interface component comprising the SSL tracking report. For instance, and in some such embodiments, the SSL tracking interface component may comprise computer readable program code that is generated to configure a GUI of a recipient user device to render the data of the SSL tracking report in a human-readable format.

In some embodiments, and as shown in block 308, the process flow 300 may include the step of configuring a graphical user interface (GUI) of a user device associated with the SSL certificate with the SSL tracking interface component. Thus, and in some such embodiments, the system may automatically transmit the SSL tracking interface component to a user device associated with a server(s) associated with the SSL certificate(s) which may be rendered in the SSL tracking report (e.g., such as a user device associated with a manager of the server, an owner of the server, an operator of the server, and/or the like), and/or a user device associated with a client device that identified the SSL certificate (such as a user that requested information on the SSL certificate at the server and/or at an associated website/entity).

Further, and in some such embodiments, by transmitting the SSL tracking interface component, the system may automatically trigger the configuration of the user device's GUI with the SSL tracking interface component to shows the SSL tracking report. In some embodiments, the user of the user device may be required to input authentication credentials to their user device and/or in the SSL tracking interface component before they can view all or only some of the SSL certificates and their associated SSL certificate data. Thus, and in some such embodiments, the SSL tracking report may block out, redact, and/or not include the SSL certificates and associated SSL certificate data where the user's authentication credentials show the user does not have the appropriate clearance to view some or all of the SSL certificates. Thus, and in some such embodiments, the SSL tracking report may be dynamically updated in real time or near real time to being sent the SSL tracking interface component to a user device.

FIG. 4 illustrates a process flow 400 for generating an SSL tracking report and configuring a graphical user interface to render the SSL tracking report on a user device, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400.

In some embodiments, and as shown in block 402, the process flow 400 may include the step of receiving, by an SSL tracking component, a user-selected SSL identifier. For example, and in some such embodiments, a user may input—using a user device or client device operatively coupled to the system described herein—a user-selected SSL identifier. Thus, and in some such embodiments, the user-selected SSL identifier may have been input by a user at a user device operatively connected (e.g., over a network) to the system described herein. In some embodiments, the user may input a website identifier (e.g., a hypertext transfer protocol (HTTP)), a common name identifier, a host server identifier, a historical SSL certificate, a current SSL identifier, and/or the like, as the user-selected SSL identifier. Therefore, and as used herein, the user-selected SSL identifier may refer to an identifier that uniquely identifies a location of an SSL certificate (which may currently be known or unknown to a user as comprising a previously known SSL certificate or as comprising a currently unknown SSL certificate). Therefore, and in other words, the user may only know the current server that hosts an SSL certificate for an entity, a historical SSL certificate that was previously known to the user, a current known SSL certificate, and/or an entity identifier/website identifier associated with a current unknown SSL certificate, and the user may wish to identify the current server, current SSL certificate, and/or current SSL certificate data for further analysis.

In some embodiments, and as shown in block 404, the process flow 400 may include the step of accessing, by the SSL tracking component, the SSL certificate in real time based on the user-selected SSL identifier. For example, and in some such embodiments, the SSL tracking component—which may be stored and operated remote from the host servers of the SSL certificates described herein—may access or extract SSL certificate in real time or near real time to receiving the user-selected SSL identifier. In some embodiments, the system may access a database, record, and/or repository, of known server identifiers associated with a website or entity identifier, server identifiers associated with a historical SSL certificate, and/or the like. In some such embodiments, the system may access each host server listed in the database from the top of the list to the bottom of the list, where the top of the list of servers may comprise those servers that were most recently accessed and where the SSL certificates were extracted correctly and without exception. Thus, and in some such embodiments, the top-most listed server may comprise the server that was most recently accessed and its associated SSL certificate was extracted from. Such an embodiment is described in further detail below with respect to FIG. 6.

In some embodiments, and as shown in block 406, the process flow 400 may include the step of generating, in an instance where the current checksum and the primary checksum do not match, an SSL tracking report comprising the SSL certificate associated with the user-selected SSL identifier and associated SSL certificate data. Thus, and in some embodiments, the system may, in an instance where the current checksum extracted from the host server associated with the user-selected SSL identifier, generate a SSL tracking report comprising the current SSL certificate extracted and its associated SSL certificate data. Thus, and as used herein, the same process of extracting the current SSL certificate and the historical SSL certificate, generating the current checksum and the primary checksum, and comparing the current checksum to the primary checksum may occur in the same manner as that described above with respect to FIG. 2.

Further, and in some embodiments, the SSL tracking report may be generated in a similar manner to the SSL tracking report generated in FIG. 3. In some embodiments, the SSL tracking report may only comprise the SSL certificate and its SSL certificate data associated with the user-selected SSL identifier. Thus, and in some such embodiments, the SSL tracking report comprising the SSL certificate and its SSL certificate data from the user-selected SSL identifier may be generated in near real time to receiving the user-selected SSL identifier. Therefore, this SSL tracking report may not have to wait until the end of a pre-determined period (or end of processing the batch of SSL certificates) to be generated and transmitted via a SSL tracking interface component to a user device.

In some embodiments, and where the primary checksum and the current checksum do match, then the system may generate an indicator that shows the user that input the user-selected SSL certificate that the historical SSL certificate has not changed or has not been updated. Thus, and in this manner, the user may determine that the historical SSL certificate has not been updated, and thus, may need further analysis or configuration to update with the SSL certificate at the host server.

In some embodiments, and as shown in block 408, the process flow 400 may include the step of configuring a graphical user interface (GUI) of a user device associated with the user-selected SSL identifier with the SSL tracking report in real time or near real time to receiving the user-selected SSL identifier. In some such embodiments, the configuration of the GUI with the SSL tracking report may occur in the same manner as that described above with respect to FIG. 3's block 306-308. Thus, and in such an embodiment, the system may generate a SSL tracking interface component with the SSL tracking report described herein, and the system may automatically transmit the SSL tracking interface component to a user device. Such a transmission of the SSL tracking interface component may automatically and in real time or near real time trigger the configuration of the user device's GUI to show the data of the SSL tracking report in a human-readable format. Thus, such a SSL tracking report, as described herein, may comprise the SSL certificate data for the host server(s) associated with the user-selected SSL identifier. Therefore, and by way of non-limiting example, where a user had updated the SSL certificate themselves and the user wanted to confirm the updated SSL certificate had worked, the user may determine—using the SSL tracking report described herein—if the historical SSL certificate had been updated for the user-selected SSL identifier.

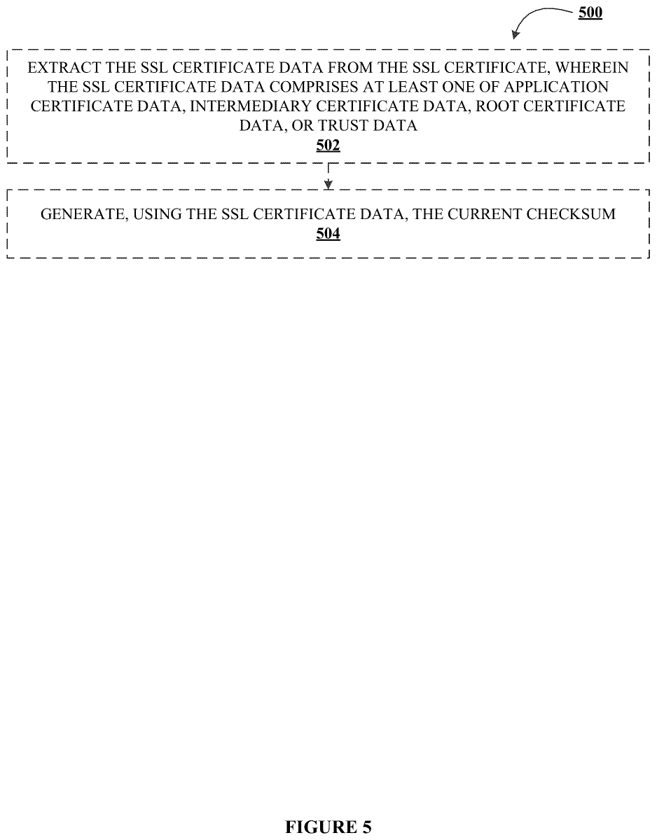

FIG. 5 illustrates a process flow 500 for generating the current checksum for an SSL certificate, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500.

In some embodiments, and as shown in block 502, the process flow 500 may include the step of extracting the SSL certificate data from the SSL certificate, wherein the SSL certificate data comprises at least one of application certificate data, intermediary certificate data, root certificate data, or trust data. For example, the system may extract the SSL certificate data, which may include but is not limited to the application certificate data (CN, issue date, expiration date), the root certificate data (CN, issue date, expiration date), root certificate data (CN, issue date, and expiration date), CA client aliases, and combine this data to generate the current checksum. In some embodiments, the system may organize the SSL certificate data in a particular sequence (e.g., such as the sequence shown above with application certificate data first to CA client aliases last) for each checksum generation, such that a false positive of an update to the historical SSL certificate is triggered. For example, and where the sequence may change but the underlying data may remain the same, the primary checksum and the current checksum may be different, and thus, may trigger an identification of an update for the historical SSL certificate.

In some embodiments, and as shown in block 504, the process flow 500 may include the step of generating, using the SSL certificate data, the current checksum. For example, and in some embodiments, the system may generate the current checksum (and the other checksums described herein) using a same process, such as a CRC32C algorithm. In some embodiments, other checksum algorithms may be used, such as but not limited to MD5 algorithm, SHA-1 algorithm, SHA-256 algorithm, SHA-512 algorithm, other such CRC algorithms, and/or the like.

FIG. 6 illustrates a process flow 600 for identifying and extracting SSL certificates and associated SSL certificate data, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600.

In some embodiments, and as shown in block 602, the process flow 600 may include the step of identifying instance data associated with the SSL certificate, wherein the instance data comprises a plurality of ports comprising the SSL certificate at a plurality of servers. For example, such instance data may refer to data associated with a connection or communication between a specific server and the client/user device in accessing the SSL certificate at the server. Thus, and in some such embodiments, the instance data may comprise data regarding any failures or errors identified in connecting the client device and the server. In some embodiments, the instance data may comprise an indicator showing that the connection is not secure, the current SSL certificate has expired at the server, an incorrect domain or common name has been used, an untrusted certificate issued by the certificate authority or identified as untrustworthy by the certificate authority, configuration malfunctions, and/or the like.

In some embodiments, a plurality of ports comprising the SSL certificate (should comprise the current or at least a historical SSL certificate for an entity, website, and/or the like), at a plurality of servers. Each port may be associated with a server, or a plurality of ports may be associated with a singular server. As used herein, a “port” refers to a communication endpoint at a server that is designed to send and receive communication between a client (or user device) and a server.

In some embodiments, and as shown in block 604, the process flow 600 may include the step of determining, based on the instance data, a prioritization list of the plurality of ports, wherein the prioritization is based on historical access to the plurality of ports. For example, and in some embodiments, the system may determine a prioritization of a plurality of ports which may be associated with one or more host servers, and based on this prioritization list, the system may attempt to access and extract the SSL certificate associated with the ports and/or servers. For example, and where the system knows the SSL certificate (e.g., such as by identification at block 202), then the system may access this prioritization list that comprises the most recently accessed ports or all historical ports accessed to gather the historical or previous SSL certificates associated with the same identified SSL certificate. In some such embodiments, the prioritization list may organize the list of ports based on most recently accessed ports without failure (the most recent being at the top of the prioritization list) to the longest ago accessed ports (the port accessed the longest time ago from the current time may be listed last). Thus, and in some such embodiments, and to conserve computing resources in accessing all the ports listed for an entity or website, the system may go down the prioritization list one-by-one until a connection is allowed and the SSL certificate and its SSL certificate data is extracted.

In some embodiments, and as shown in block 608, the process flow 600 may include the step of attempting a connection with each port on the prioritization list until a port is accessible. For instance, and in some such embodiments, the system may attempt a connection with each port on the prioritization list until a port is accessible and the SSL certificate and its SSL certificate data can be extracted. In some embodiments, and where a port on the list cannot be accessed and the SSL certificate cannot be extracted, the system may track this as an exception and evaluate these exceptions to assist the user in addressing any critical SSL issues within these instances comprising these exceptions. Such an embodiment is described in further detail below.

In some embodiments, the system may attempt connection to all ports in parallel and/or in a sequence from top to bottom within the prioritization list. For instance, and in a preferred embodiment of the system, the system may attempt access to each of the ports in sequence of the prioritization list until a port is accessible (from top to bottom). However, and in some embodiments, the system may attempt access each of the ports listed in the prioritization list in parallel and at once, and may only stop when one of the ports is accessible and an SSL certificate and its SSL certificate data can be extracted.

In some embodiments, and as shown in block 610, the process flow 600 may include the step of extracting the SSL certificate from the first port that is accessible. For example, and in some such embodiments, the system may extract the SSL certificate from the first port that is accessible, even if that first port that is accessible is not the first port listed in the prioritization list (e.g., the first port listed may not have been accessible, online, and/or the like). As used herein, this extraction of the SSL certificate and its SSL certificate data may occur in the same or similar manner to the extraction process described hereinabove. Additionally, and in an instance where a port is accessible and the SSL certificate is extracted correctly, then the system may stop the instance and/or send a trigger to halt the instance even if there are more ports listed below in the prioritization list. In this manner, computing resources may be conserved as not all ports or servers will need to be accessed.

In some embodiments, and as shown in block 612, the process flow 600 may include the step of collecting, in an instance where the plurality of ports in the prioritization list are inaccessible, each exception for each port that is inaccessible. For example, and in some such embodiments, the system may collect each exception for each port that was inaccessible. Such a collection may occur in real time as the instance data shows the port was inaccessible, and upon collecting the instance data for each inaccessible port (or in real time during the collection of each inaccessible port), the system may evaluate the data surrounding the exception. For instance, the system may determine why the exception occurred based on the instance data collected. For example, data may be extracted from these exceptions, evaluated, and data can be extrapolated based on the type of exception events.

In some embodiments, and as shown in block 614, the process flow 600 may include the step of analyzing each exception and associated exception data. For instance, the system may analyze each exception and associated exception data to determine the likely exception event that occurred. For example, if all the exceptions for an instance at a particular port are associated with a bad handshake (e.g., bad communication), the system may determine the instance is not listening on the SSL port and the user may need to update the instance data to indicate the SSL certificate is not being used. As a further example, the system may also determine the instance port data is not accurate, and the user may need to update the instance data to reflect the accurate port details.

Additionally, and by way of non-limiting example, where the connection attempts timeout or the connection is outright refused, the system may determine the instance is offline (e.g., the port is offline), and the user may need to update the address of another port. As a further example, the system may also determine the instance details are incompatible or inaccurate, and the user may need to update the instance data to reflect accurate network data.

In some embodiments, exception data detailed herein may configured in the SSL tracking report and presented to the user via the SSL tracking interface component at the user device's GUI.

In some embodiments, and as shown in block 616, the process flow 600 may include the step of generating an SSL exception report interface component comprising the exception data for each exception. For instance, the system may generate an SSL exception report interface component that comprises the exception data for each exception and any further details, evaluation, or analysis done by the system described herein, such as but not limited to determining exception events from the instance data.

In some embodiments, and as shown in block 618, the process flow 600 may include the step of configuring a graphical user interface of a user device with the SSL exception report interface component. For example, the configuration of the GUI with the SSL tracking report may occur in the same manner as that described above with respect to FIG. 3's block 306-308. Thus, and in such an embodiment, the system may generate a SSL tracking interface component with the SSL tracking report described herein, and the system may automatically transmit the SSL tracking interface component to a user device. Such a transmission of the SSL tracking interface component may automatically and in real time or near real time trigger the configuration of the user device's GUI to show the data of the SSL tracking report in a human-readable format. Thus, such a SSL tracking report, as described herein, may comprise the SSL certificate data for the host server(s) associated with the user-selected SSL certificate.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for automatically scanning secure sockets layer certificates in a distributed network, the system comprising:
a memory device with computer-readable program code stored thereon;
at least one processing device operatively coupled to the memory device and at least one communication device, wherein executing the computer-readable code is configured to cause the at least one processing device to:
identify a secure sockets layer (SSL) certificate from at least one server;
extract SSL certificate data from the SSL certificate;
generate a current checksum for the SSL certificate based on the SSL certificate data;
access a primary checksum associated with the SSL certificate, wherein the primary checksum is based on a historical SSL certificate from the at least one server or a related server;
compare the current checksum to the primary checksum; and
determine, based on the comparison of the current checksum to the primary checksum, the SSL certificate matches or does not match the historical SSL certificate for the at least one server.

2. The system of claim 1, wherein the historical SSL certificate and the primary checksum are accessed via an SSL tracking component stored remote from the at least one server or the related server, and wherein executing the computer-readable code is further configured to cause the at least one processing device to:
update, in an instance where the current checksum and the primary checksum do not match, the primary checksum and the historical SSL certificate in the SSL tracking component with the current checksum and the SSL certificate data.

3. The system of claim 2, wherein executing the computer-readable code is further configured to cause the at least one processing device to:
generate, based on updating the primary checksum and the historical SSL certificate in the SSL tracking component, an SSL tracking report comprising each of the historical SSL certificates that have been updated within a pre-determined period;
generate an SSL tracking interface component comprising the SSL tracking report; and
configure a graphical user interface of a user device associated with the SSL certificate with the SSL tracking interface component.

4. The system of claim 3, wherein a batch of SSL certificates is identified from a plurality of servers over the pre-determined period, and wherein the pre-determined period comprises at least one of twenty-four hours, seven days, or a month.

5. The system of claim 1, wherein executing the computer-readable code is further configured to cause the at least one processing device to:
receive, by an SSL tracking component, a user-selected SSL identifier;
access, by the SSL tracking component, the SSL certificate in real time based on the user-selected SSL identifier;
generate, in an instance where the current checksum and the primary checksum do not match, an SSL tracking report comprising the SSL certificate associated with the user-selected SSL identifier and associated SSL certificate data; and
configure a graphical user interface of a user device associated with the user-selected SSL identifier with the SSL tracking report in real time or near real time to receiving the user-selected SSL identifier.

6. The system of claim 1, wherein the historical SSL certificate and the primary checksum are accessed via an SSL tracking component stored remote from the at least one server or the related server, and wherein, in an instance where the current checksum and the primary checksum match, the primary checksum in the SSL tracking component remains unchanged.

7. The system of claim 6, wherein the SSL tracking component stores a timestamp of the current checksum with the primary checksum and the historical SSL certificate.

8. The system of claim 1, wherein executing the computer-readable code is further configured to cause the at least one processing device to:
extract the SSL certificate data from the SSL certificate, wherein the SSL certificate data comprises at least one of application certificate data, intermediary certificate data, root certificate data, or trust data; and
generate, using the SSL certificate data, the current checksum.

9. The system of claim 1, wherein executing the computer-readable code is further configured to cause the at least one processing device to:
identify instance data associated with the SSL certificate, wherein the instance data comprises a plurality of ports comprising the SSL certificate at a plurality of servers;
determine, based on the instance data, a prioritization list of the plurality of ports, wherein the prioritization is based on historical access to the plurality of ports;
attempt a connection with each port on the prioritization list until a port is accessible; and
extract the SSL certificate from the first port that is accessible.

10. The system of claim 9, wherein executing the computer-readable code is further configured to cause the at least one processing device to:
collect, in an instance where the plurality of ports in the prioritization list are inaccessible, each exception for each port that is inaccessible;
analyze each exception and associated exception data;
generate an SSL exception report interface component comprising the exception data for each exception; and
configure a graphical user interface of a user device with the SSL exception report interface component.

11. A computer program product for automatically scanning secure sockets layer certificates in a distributed network, wherein the computer program product comprises at least one non-transitory computer-readable medium having computer-readable program code portions embodied therein, the computer-readable program code portions which when executed by a processing device are configured to cause the processor to:
identify a secure sockets layer (SSL) certificate from at least one server;
extract SSL certificate data from the SSL certificate;
generate a current checksum for the SSL certificate based on the SSL certificate data;
access a primary checksum associated with the SSL certificate, wherein the primary checksum is based on a historical SSL certificate from the at least one server or a related server;
compare the current checksum to the primary checksum; and
determine, based on the comparison of the current checksum to the primary checksum, the SSL certificate matches or does not match the historical SSL certificate for the at least one server.

12. The computer program product of claim 11, wherein the historical SSL certificate and the primary checksum are accessed via an SSL tracking component stored remote from the at least one server or the related server, and wherein the computer-readable program code portions which when executed by the processing device are configured to cause the processor to:
update, in an instance where the current checksum and the primary checksum do not match, the primary checksum and the historical SSL certificate in the SSL tracking component with the current checksum and the SSL certificate data.

13. The computer program product of claim 12, wherein the computer-readable program code portions which when executed by the processing device are configured to cause the processor to:
generate, based on updating of the primary checksum and the historical SSL certificate in the SSL tracking component, an SSL tracking report comprising each of the historical SSL certificates that have been updated within a pre-determined period;
generate an SSL tracking interface component comprising the SSL tracking report; and
configure a graphical user interface of a user device associated with the SSL certificate with the SSL tracking interface component.

14. The computer program product of claim 13, wherein a batch of SSL certificates is identified from a plurality of servers over the pre-determined period, and wherein the pre-determined period comprises at least one of twenty-four hours, seven days, or a month.

15. The computer program product of claim 11, wherein the computer-readable program code portions which when executed by the processing device are configured to cause the processor to:
receive, by an SSL tracking component, a user-selected SSL identifier;
access, by the SSL tracking component, the SSL certificate in real time based on the user-selected SSL identifier;
generate, in an instance where the current checksum and the primary checksum do not match, an SSL tracking report comprising the SSL certificate associated with the user-selected SSL identifier, and associated SSL certificate data; and
configure a graphical user interface of a user device associated with the user-selected SSL identifier with the SSL tracking report in real time or near real time to receiving the user-selected SSL identifier.

16. A computer implemented method for automatically scanning secure sockets layer certificates in a distributed network, the computer implemented method comprising:
identify a secure sockets layer (SSL) certificate from at least one server;
extract SSL certificate data from the SSL certificate;
generate a current checksum for the SSL certificate based on the SSL certificate data;
access a primary checksum associated with the SSL certificate, wherein the primary checksum is based on a historical SSL certificate from the at least one server or a related server;
compare the current checksum to the primary checksum; and
determine, based on the comparison of the current checksum to the primary checksum, the SSL certificate matches or does not match the historical SSL certificate for the at least one server.

17. The computer implemented method of claim 16, wherein the historical SSL certificate and the primary checksum are accessed via an SSL tracking component stored remote from the at least one server or the related server, further comprising:
update, in an instance where the current checksum and the primary checksum do not match, the primary checksum and the historical SSL certificate in the SSL tracking component with the current checksum and the SSL certificate data.

18. The computer implemented method of claim 17, further comprising:
generate, based on updating of the primary checksum and the historical SSL certificate in the SSL tracking component, an SSL tracking report comprising each of the historical SSL certificates that have been updated within a pre-determined period;
generate an SSL tracking interface component comprising the SSL tracking report; and
configure a graphical user interface of a user device associated with the SSL certificate with the SSL tracking interface component.

19. The computer implemented method of claim 18, wherein a batch of SSL certificates is identified from a plurality of servers over the pre-determined period, and wherein the pre-determined period comprises at least one of twenty-four hours, seven days, or a month.

20. The computer implemented method of claim 17, further comprising:
receive, by an SSL tracking component, a user-selected SSL identifier;
access, by the SSL tracking component, the SSL certificate in real time based on the user-selected SSL identifier;
generate, in an instance where the current checksum and the primary checksum do not match, an SSL tracking report comprising the SSL certificate associated with the user-selected SSL identifier, and associated SSL certificate data; and
configure a graphical user interface of a user device associated with the user-selected SSL identifier with the SSL tracking report in real time or near real time to receiving the user-selected SSL identifier.
